(19) United States
(12) Patent Application Publication
(10) Pub. No.: US 2014/0306154 A1
(43) Pub. Date: Oct. 16, 2014

(54) Freezer/Fridge Mats

(71) Applicant: Texanne Holloway, Brooklyn, NY (US)

(72) Inventor: Texanne Holloway, Brooklyn, NY (US)

(21) Appl. No.: 14/249,801

(22) Filed: Apr. 10, 2014

Related U.S. Application Data
(60) Provisional application No. 61/810,655, filed on Apr. 10, 2013.

(51) Int. Cl. B01J 20/28; B01J 20/22

(52) U.S. Cl. CPC B01J 20/2804; B01J 20/22; B01J 20/28038
USPC 252/193; 502/401

(57) ABSTRACT

Freezer/Fridge Mats, is a line absorbent, odor absorbing and disposable mats that are easily applied to refrigerator and freezer shelves and drawers to easily and effectively maintain a clean and sanitary refrigerator. Freezer Fridge Mats are manufactured with an absorbent sanitary paper material or comparable biodegradable synthetic blend. Each Freezer Fridge Mats is rectangular in shape and is perforated and easily cut to fit various size drawers and shelving. Freezer Fridge Mats are infused with baking soda to absorb odors and provide optimal refrigerator and freezer freshness.

### CLAIM OF PRIORITY

This patent application claims priority under 35 USC 119 (e) (1) from U.S. Provisional Patent Application Ser. No. 61/810,655 filed Apr. 10, 2013, of common inventorship herewith entitled, “Freezer/Fridge Mats.”

### FIELD OF THE INVENTION

The present invention pertains to the field of sanitizers, and more specifically to the field of sanitizing liners for shelving and floors.

### BACKGROUND OF THE INVENTION

The prior art has put forth several designs for sanitizing liners for shelving and floors. Among these are:

U.S. Pat. No. 6,926,862 to Monica Carlise Fontenot, Terry Pearce Ford, John Wesley Fowler, Jeanette Ann Allen, Ryan Clinton Frank, Gina Kay Rolsten, Richard John Schmidt and Bruce Scott Williamson describes a container liner, shelf liner or drawer liner that absorbs liquids spilled or leaked into a container or onto a shelf or drawer. The liner is a layered product having a layer which is impervious to liquids and an absorbent layer. The absorbent layer further contains a material which is capable of controlling odors such as those odors found in refrigerators and waste receptacles. The liner of the present invention provides the benefit of absorbing spills and controlling odors in containers such as refrigerators and waste receptacles.

U.S. Pat. No. 6,245,697 to Jonnie Pehrson Conrad, John C. Dyer, Thomas C. Hortel and Roxanne Drago Westendorf describes protective flexible mats for absorbing liquids on floors and other surfaces which contain a waterproof component and a polymeric foam sheet formed by polymerizing a high internal phase water in oil emulsion. The mats also contain a nonskid material and at least one liquid pervious sheet. The mats are suitable for absorbing hydrophilic and hydrophobic liquids.

US Patent 2009/0004433 to Marc Privitera, David Lestage, Gregory Van Buskirk, Jessica Chung, Elizabeth Lane, Marcus Wang and Jason White describes a plastic film that includes one or more plastic layers and one or more types of primary additives. The types of primary additive include a liquid absorbing material, a gas absorbing material, a biocide, a heat generating material and a foaming agent.

None of these prior art references describe the present invention.

### SUMMARY OF THE INVENTION

It is an object of the present invention to provide a liquid absorbent, odor absorbent, disposable and biodegradable mat for refrigerator and freezer shelving.

### BRIEF DESCRIPTION OF THE DRAWINGS

FIG. 1 is a prototypical illustrative top diagonal view show mats with baking soda to absorb odors and leaks inside a refrigerator.

FIG. 2 is a functional illustrative front view inside a refrigerator showing mats placed on refrigerator shelves.

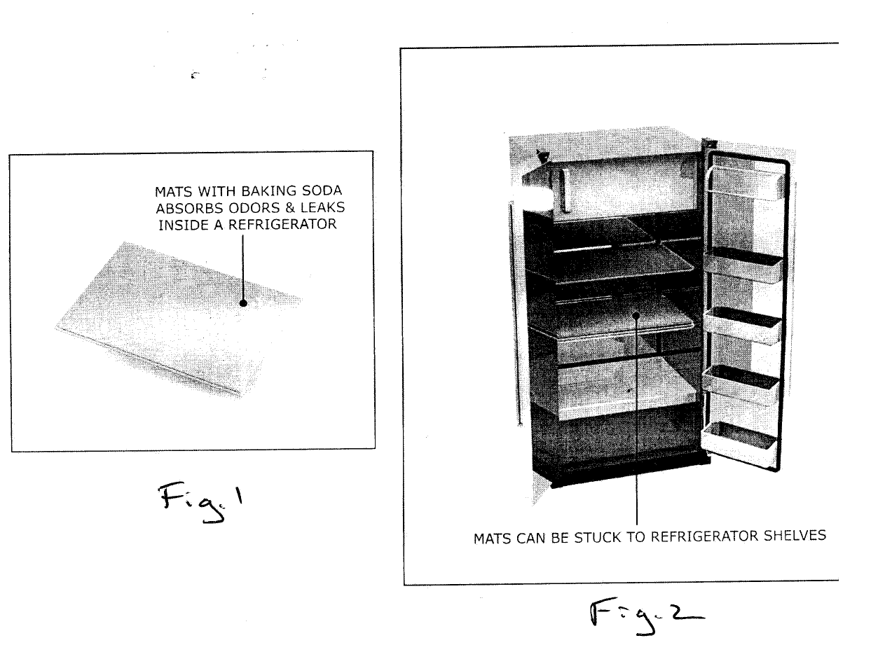

### DETAILED DESCRIPTION OF THE INVENTION

Household chores are an unavoidable fact of life for most consumers. Maintaining a clean kitchen is an utmost concern for many consumers. The kitchen is a gathering place within the home where family meals are prepared and eaten. Many people use their kitchens as a workspace for children to do their homework or for adults to write bills or balance the checkbook. The kitchen is an area where people sit and talk on the phone or hold court with family members and friends. Because the kitchen is such a vital component of any home, most consumers take careful steps to make sure this room is clean and sanitary. Specifically, cleaning away spills and food debris from the interior of one's refrigerator and freezer is an important chore regularly completed by most household consumers. Most refrigerator shelving is comprised of rubber coated wire racks, solid glass or plastic shelves, and removable drawers. Providing ample space on which to store gallons of milk, condiments, luncheon meats, produce, containers of ice cream, frozen vegetables and a host of other goods, shelving and drawers are integral to any refrigerator and freezer design.

While racks, shelves and drawers are necessary components of any refrigerator, many consumers find that actually cleaning these components is difficult. In the case of rubber coated racks, rust stains caused by exposed wire are practically inevitable, requiring an arduous task of scrubbing and scouring racks to make them appear presentable. Because of their open design, racks often are unsuited for storing small bottles and containers. A container of ice cream on a freezer rack can topple over and leak sticky contents onto a bin of ice, frozen foods and shelving. In the case of solid shelving, the task of removing the shelves becomes a hassle. Refrigerator and shelves typically serve the dual purpose of providing storage and a cover for vegetable crispers and storage drawers, so they are contoured to conform to the shape of the drawer below. Liquids and debris easily pool on the surface of these shelves and drawers, forming a crusty hard residue that is difficult to remove. In addition, this food residue can cause noxious odors that can be absorbed by other foods. Requiring the consumer to remove entire shelves and drawers, simply in order to eradicate this debris and eliminate these, maintaining a clean refrigerator can be a time consuming and daunting task.

The present invention, hereinafter referred to as Freezer Fridge Mats, is a line absorbent, odor absorbing and disposable mats that are easily applied to refrigerator and freezer shelves and drawers. The function of the present invention is to easily and effectively maintain a clean and sanitary refrigerator. Freezer Fridge Mats are manufactured with an absorbent sanitary paper material or comparable biodegradable synthetic blend. Each Freezer Fridge Mats is rectangular in shape and measures approximately sixty inches in length, twenty two inches in width and one half inch in depth. Smaller and larger versions of Freezer Fridge Mats are available. The present invention is perforated and easily cut to fit various size drawers and shelving. Encompassing an entire surface area, Freezer Fridge Mats are placed atop an empty shelf or within an empty drawer. Perishable items are then placed directly on a Freezer Fridge mat. Freezer Fridge Mats are infused with baking soda to absorb odors and provide optimal refrigerator and freezer freshness. Freezer Fridge Mats are available in several grades that ensure refrigerator and freezer freshness from thirty days up to six months. The present invention is packaged in bulk and available in sheet, roll or dispenser form.

Application and use of Freezer Fridge Mats is very simple and straightforward. A user purchases a package of Freezer Fridge Mats in accordance to the number of refrigerator and freezer shelves and drawers they wish to cover. All items are removed from the refrigerator and freezer in preparation for lining. A one step application, the user places a Freezer Fridge Mat directly on top of the designated rack or shelf, positioning the mat so that it encompasses the shelf completely. The user also purchases smaller mats or cuts the larger mats to fit drawers and other bins incorporated into the design of the refrigerator and freezer. These smaller mats also are placed in compartments located inside the appliance's door. Once the Freezer Fridge Mats are installed, the user reloads the refrigerator and freezer with foods and beverages, placing these items directly atop the covered areas. During use, baking soda incorporated into the Freezer Fridge mat serves to thwart and neutralize odors, while the super absorbent material of the mat captures spills and leaks, ensuring shelving and drawers remain clean and dry. Periodically, the user removes the Freezer Fridge Mats, properly disposes of them and replaces them with a new set of mats.

Preventing spilled liquids, food crumbs, spoiled fruits and other debris from soiling the refrigerator and freezer interior, using Freezer Fridge Mats helps consumers to clean their appliances in an easy and expedient manner. The present invention absorbs and neutralizes noxious odors associated with spoiled and spilled foods. Freezer Fridge Mats extend the life of shelving, preventing rust and other stains from forming and slowly deteriorating the shelving surfaces. Fashioned of biodegradable material, the present invention maintains a healthy environment as well as a clean kitchen. Freezer Fridge Mats function equally well in maintaining a hygienic environment in domestic households, public restaurants and other food facilities.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A liquid absorbent, odor absorbent, disposable and biodegradable mat for refrigerator and freezer shelving, comprising:
absorbent sanitary paper material or comparable biodegradable synthetic blend.

2. The liquid absorbent, odor absorbent, disposable and biodegradable mat for refrigerator and freezer shelving of claim 1 wherein the mat is rectangular in shape and measures approximately sixty inches in length, twenty two inches in width and one half inch in depth.

3. The liquid absorbent, odor absorbent, disposable and biodegradable mat for refrigerator and freezer shelving of claim 1 wherein the mat is perforated and easily cut to fit various size drawers and shelving.

4. The liquid absorbent, odor absorbent, disposable and biodegradable mat for refrigerator and freezer shelving of claim 1 wherein the mat is infused with baking soda to absorb odors and provide optimal refrigerator and freezer freshness.

5. The liquid absorbent, odor absorbent, disposable and biodegradable mat for refrigerator and freezer shelving of claim 1 available in several grades that ensure refrigerator and freezer freshness from thirty days up to six months.

6. The liquid absorbent, odor absorbent, disposable and biodegradable mat for refrigerator and freezer shelving wherein the mat is packaged in bulk and available in sheet, roll or dispenser form.
